(19) United States
(12) Patent Application Publication
(10) Pub. No.: US 2015/0088616 A1
(43) Pub. Date: Mar. 26, 2015

(54) METHOD, SOFTWARE AND DEVICE FOR AUTOMATICALLY SCORING PRIVACY PROTECTION BASED ON EVIDENCE

(71) Applicant: Terry McQuay, Toronto (CA)

(72) Inventor: Terry McQuay, Toronto (CA)

(73) Assignee: NYMITY INC., Toronto (CA)

(21) Appl. No.: 14/035,189

(22) Filed: Sep. 24, 2013

Related U.S. Application Data
(60) Provisional application No. 61/880,576, filed on Sep. 20, 2013.

(51) Int. Cl. G06Q 10/06

(52) U.S. Cl. CPC G06Q 10/06395
USPC 705/7.41

(57) ABSTRACT

Methods, software, and devices for scoring performance of a plurality of privacy protection activities by an organization are disclosed. A plurality of electronic reports are received, with each report indicating that the organization performs one of the privacy protection activities and providing evidence that the organization has performed that privacy protection activity. A plurality of lifespan metrics are maintained, each measuring a lifespan for an associated one of the electronic reports, after which evidence provided in that electronic report is deemed to have expired. A score reflective of extent of performance of the privacy protection activities by the organization is calculated. The calculation takes into account the plurality of electronic reports that provide evidence that has not expired.

### CROSS-REFERENCE TO RELATED APPLICATIONS

This application claims priority from U.S. Provisional Patent Application No. 61/880,576 filed Sep. 20, 2013, the contents of which are hereby incorporated herein by reference.

### TECHNICAL FIELD

This relates to scoring organizational privacy protection, and more particularly, to automatically scoring organizational privacy protection based on evidence of activities performed.

### BACKGROUND

In Canada, the Personal Information Protection and Electronic Documents Act was enacted in 2004 to govern how private sector organizations may collect, use, and disclose personal information in the course of business. Similar legislation exists in other countries, such as, for example, the United Kingdom's Data Protection Act, Mexico's Federal Law of Protection of Personal Data held by Private Parties, and Hong Kong's Personal Data (Privacy) Ordinance.

As such, many organizations have adopted privacy protection measures to protect personal information in manners that comply with applicable privacy legislation. However, it is often difficult for organizations to assess the extent to which those measures are implemented, and thus it is difficult for organizations to assess its compliance with privacy legislation. In particular, assessments are typically based on subjective evaluations that are error prone and/or inconsistent. Further, assessments are often only performed sporadically on an ad hoc basis, and thus the results of such assessments are often stale. These challenges may be especially difficult to overcome for large organizations, in which applicable privacy legislation, policies and procedures and implementation thereof, may vary throughout the organization.

Accordingly, there remains a need for improved methods, software and devices for assessing an organization's implementation of privacy protection measures.

### SUMMARY

According to an aspect, there is provided a computer-implemented method of scoring performance of a plurality of privacy protection activities by an organization. The method includes receiving a plurality of electronic reports, each of the electronic reports indicating that the organization performs one of the plurality of privacy protection activities and providing evidence that the organization has performed the privacy protection activity; maintaining a plurality of lifespan metrics, each measuring a lifespan for an associated one of the electronic reports, after which the evidence provided in that electronic report is deemed to have expired; and calculating a score reflective of extent of performance of the plurality of privacy protection activities by the organization, taking into account those of the plurality of electronic reports providing evidence that has not expired.

According to another aspect, there is provided a computing device for scoring performance of a plurality of privacy protection activities by an organization. The device includes at least one processor; memory in communication with the at least one processor; and software code stored in the memory. The software code, when executed by the at least one processor causes the computing device to: receive a plurality of electronic reports, each of the electronic reports indicating that the organization performs one of the plurality of privacy protection activities and providing evidence that the organization has performed the privacy protection activity; maintain a plurality of lifespan metrics, each measuring a lifespan for an associated one of the electronic reports, after which the evidence provided in that electronic report is deemed to have expired; and calculate a score reflective of extent of performance of the plurality of privacy protection activities by the organization, taking into account those of the plurality of electronic reports providing evidence that has not expired.

According to yet another aspect, there is provided a computer-readable medium storing instructions which when executed adapt a computing device to: receive a plurality of electronic reports, each of the electronic reports indicating that a organization performs a particular privacy protection activity of a plurality of privacy protection activities, and providing evidence that the organization has performed the particular privacy protection activity; maintain a plurality of lifespan metrics, each measuring a lifespan for an associated one of the electronic reports, after which the evidence provided in that electronic report is deemed to have expired; and calculate a score reflective of extent of performance of the plurality of privacy protection activities by the organization, taking into account those of the plurality of electronic reports providing evidence that has not expired.

According to a yet further aspect, there is provided a computer-implemented method of scoring performance of a plurality of privacy protection activities by an organization. The method includes: receiving a plurality of electronic reports, each of the electronic reports indicating that the organization performs one of the plurality of privacy protection activities and providing evidence that the organization has performed the privacy protection activity; and calculating a score reflective of extent of performance of the plurality of privacy protection activities by the organization, taking into account the plurality of electronic reports.

Other features will become apparent from the drawings in conjunction with the following description.

### BRIEF DESCRIPTION OF THE DRAWINGS

In the figures which illustrate example embodiments,

FIG. 1 is a network diagram illustrating a computer network, a server, and end-user devices interconnected to the network, exemplary of an embodiment;

FIG. 2 is a high level block diagram of a computing device for use as the server of FIG. 1;

FIG. 3 illustrates the software organization of the server of FIG. 1;

FIG. 4 is a diagram illustrating a database schema for a database stored at the server of FIG. 1;

FIG. 5 is a high level block diagram of the modules of the reporting/scoring software of FIG. 3 executed at the server of FIG. 1;

FIG. 6A and FIG. 6B each illustrate an exemplary user interfaces for specifying relative importance of organizational units;

FIG. 7 illustrates an exemplary user interface for specifying relative importance of privacy protection processes;

FIG. 8 illustrates an exemplary user interface for specifying a new privacy protection activity;

FIG. 9 illustrates an exemplary user interface for specifying relative importance of privacy protection activities;

FIG. 10 illustrates an exemplary user interface for creating an electronic report reporting performance of a particular privacy protection activity, and providing evidence thereof;

FIG. 11 illustrates an exemplary user interface showing scoring results; and

FIG. 12 is a flowchart depicting exemplary blocks performed by the reporting/scoring software of FIG. 3.

### DETAILED DESCRIPTION

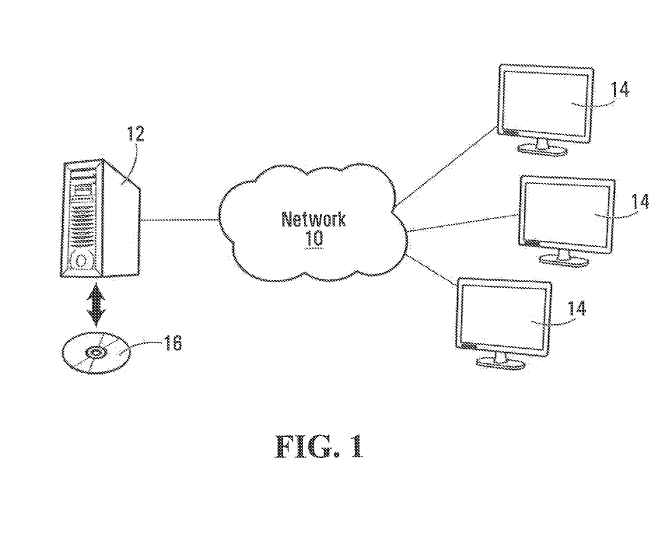

FIG. 1 illustrates a computer network and network interconnected server 12, exemplary of an embodiment. As will become apparent, server 12 is a computing device that includes software that facilitates electronic reporting of privacy protection activities performed by an organization and electronic reporting of evidence thereof. This software automatically scores the organization's performance of privacy protection activities based on received electronic reports.

As illustrated, server 12 is in communication with other computing devices such as end-user computing devices 14 through computer network 10. Network 10 may be the public Internet, but could also be a private intranet. So, network 10 could, for example, be an IPv4, IPv6, X.25, IPX compliant or similar network. Network 10 may include wired and wireless points of access, including wireless access points, and bridges to other communications networks, such as GSM/GPRS/3G/LTE or similar wireless networks. When network 10 is a public network such as the public Internet, it may be secured as a virtual private network.

Example end-user computing devices 14 are illustrated. End-user computing devices 14 are conventional network-interconnected computing devices used to access data and services through a suitable HTML browser or similar interface from network interconnected servers, such as server 12. As will become apparent, computing devices 14 are operated by users to interact with software executing at server 12. For example, computing devices 14 may be operated by users to submit electronic reports regarding an organization's performance of privacy protection activities. Conveniently, when server 12 is interconnected with multiple computing devices 14, multiple users throughout the organization, e.g., situated in different organizational units, may submit electronic reports, thereby allowing data to be compiled collaboratively.

The architecture of computing devices 14 is not specifically illustrated. Each computing device 14 may include a processor, network interface, display, and memory, and may be a desktop personal computer, a laptop computing device, a tablet computing device, a mobile phone, or the like. Computing devices 14 may access server 12 by way of network 10. As such, computing devices 14 typically store and execute network-aware operating systems including protocol stacks, such as a TCP/IP stack, and web browsers such as Microsoft Internet Explorer, Mozilla Firefox, Google Chrome, Apple Safari, or the like.

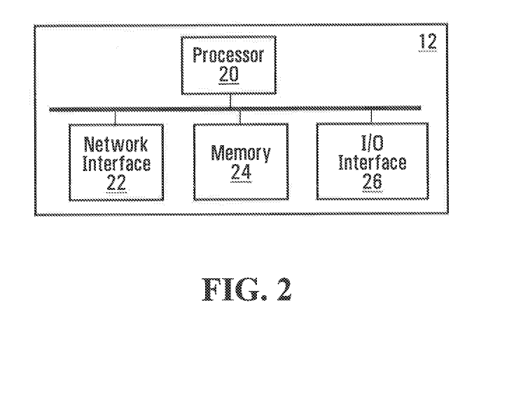

FIG. 2 is a high-level block diagram of a computing device that may act as server 12. As illustrated, server 12 includes one or more processors 20, network interface 22, a suitable combination of persistent storage memory 24, random-access memory and read-only memory, one or more I/O interfaces 26. Processor 20 may be an Intel x86, PowerPC, ARM processor or the like. Network interface 22 interconnects server 12 to network 10. Memory 24 may be organized using a conventional filesystem, controlled and administered by an operating system governing overall operation of server 12. Server 12 may store in memory 24, through this filesystem, software for receiving data from users regarding implementation/compliance, and for scoring implementation/compliance based on received data, as detailed below. Server 12 may include input and output peripherals interconnected to server 12 by one or more I/O interfaces 26. These peripherals may include a keyboard, display and mouse. These peripherals may also include devices usable to load software to be executed at server 12 into memory 24 from a computer readable medium, such as computer readable medium 16 (FIG. 1).

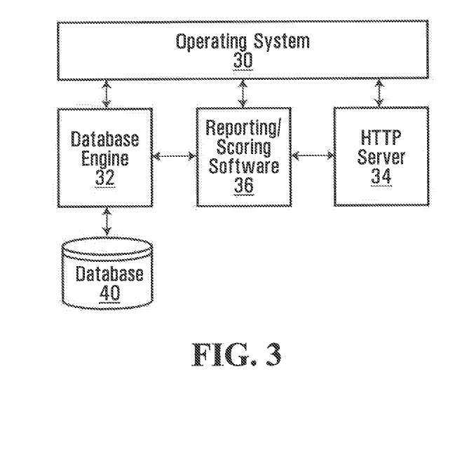

FIG. 3 illustrates a simplified organization of example software components stored within memory 24 of server 12, as depicted in FIG. 2. As illustrated, software components includes operating system (OS) software 30, database engine 32, a hypertext transfer protocol (“HTTP”) server application 34, and reporting/scoring software 36. Server 12 executes these software components to adapt it to operate in manners of embodiments, as detailed below.

OS software 30 may, for example, be a Unix-based operating system (e.g., Linux, FreeBSD, Solaris, Mac OS X, etc.), a Microsoft Windows operating system or the like. OS software 30 allows reporting/scoring software 36 to access processor 20, network interface 22, memory 24, and one or more I/O interfaces 26 of server 12. OS software 30 may include a TCP/IP stack allowing server 12 to communicate with interconnected computing devices, such as computing devices 14, through network interface 22 using TCP/IP.

Database engine 32 may be a conventional relational, object-oriented, or document-oriented database engine. Database engine 32 may be a SQL-based or a NoSQL database engine. Database engine 32 may be an ACID (Atomicity, Consistency, Isolation, Durability) compliant database engine or a non-ACID database engine. As such, database engine 32 may be, for example, Microsoft SQL Server, Oracle, DB2, Sybase, Pervasive, MongoDB, or any other database engine known to those skilled in the art. Database engine 32 provides access to one or more databases 40, and thus typically includes an interface for interaction with OS software 30, and other software, such as reporting/scoring software 36.

Database 40 may be a relational, object-oriented, or document-oriented database. As will become apparent, database 40 stores records reflective of parameters of an organization, parameters of reporting models, parameters of privacy protection activities to be performed, reports regarding performance of privacy protection activities, and evidence of such performance. Reporting/scoring software 36 may access database 40 by way of database engine 32. Database 40 may be stored in memory 24 of server 12.

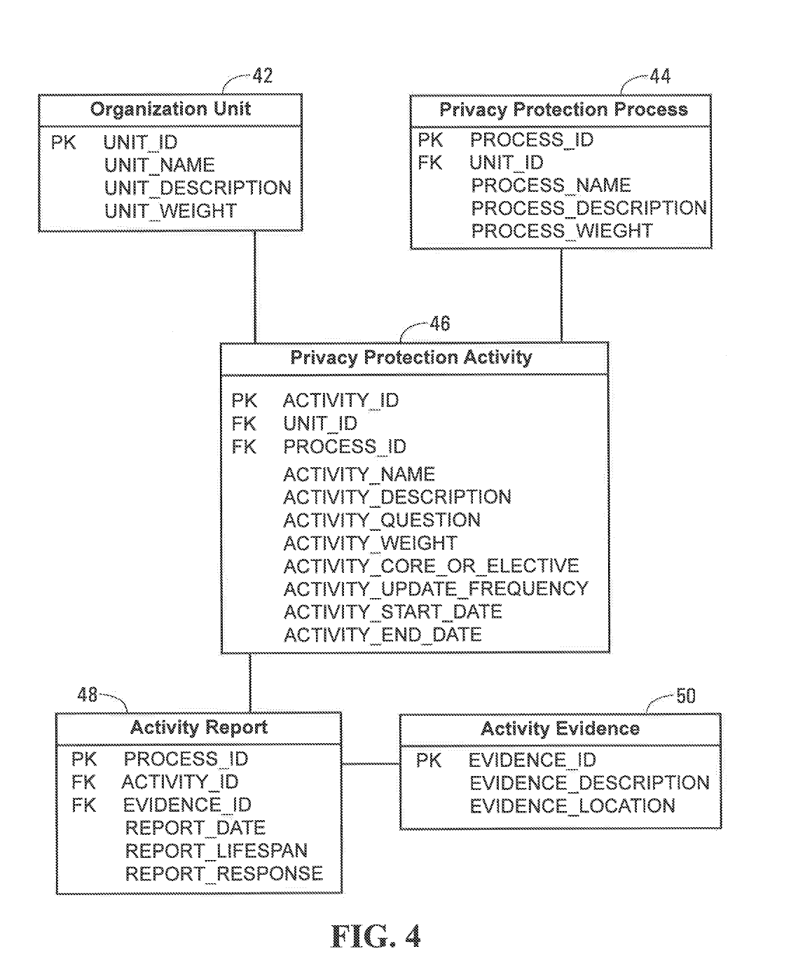

A simplified example organization of database 40 is illustrated in FIG. 4, exemplary of an embodiment. As illustrated, database 40 is organized as a plurality of tables. Specifically, database 40 includes organizational unit table 42, privacy protection process table 44, privacy protection activity table 46, activity report table 48, and activity evidence table 50.

Organizational unit table 42 includes entries corresponding to particular constituent organizational units of an organization. As depicted, each entry includes a UNIT_ID field uniquely identifying an organizational unit, a UNIT_NAME field containing a name for the organizational unit, a UNIT_DESCRIPTION field containing a description of the organizational unit, and a UNIT_WEIGHT field containing a numerical weight representative of the importance of the organizational unit.

Privacy protection process table 44 includes entries corresponding to particular privacy protection processes implemented by a particular organizational unit of an organization, examples of which are detailed below. As depicted, each entry includes a PROCESS_ID field uniquely identifying a privacy protection process, a UNIT_ID field uniquely identifying an organizational unit expected to implement the process (corresponding to the UNIT_ID field of organizational unit table 42), a PROCESS_NAME field containing a name for the process, a PROCESS_DESCRIPTION field containing a description of the process, and a PROCESS_WEIGHT field containing a numerical weight representative of the importance of the process.

Privacy protection activity table 46 includes entries corresponding to particular privacy protection activities performed by a particular organizational unit of an organization. As depicted, each entry includes an ACTIVITY_ID field uniquely identifying an activity, a UNIT_ID field identifying an organizational unit expected to perform the activity (corresponding to the UNIT_ID field of organizational unit table 42), a PROCESS_ID field uniquely identifying a privacy protection process to which the activity belongs (corresponding to the PROCESS_ID field of privacy protection process table 42). Each entry of privacy protection activity table 46 also includes an ACTIVITY_NAME field containing a name for the activity, an ACTIVITY_DESCRIPTION field containing a description of the activity, an ACTIVITY_QUESTION field containing a question posed to users to determine whether or not the activity has been performed, an ACTIVITY_WEIGHT field containing a numerical weight representative of the importance of the activity, an ACTIVITY_CORE_OR_ELECTIVE field containing an indicator of whether the activity is a core activity or elective activity, an ACTIVITY_UPDATE_FREQUENCY field containing an indicator of how frequently a new report regarding performance of the activity is expected (e.g., annually, semi-annually, quarterly, monthly, etc.), an ACTIVITY_START_DATE field indicating when performance of the activity is scheduled to begin, and an ACTIVITY_END_DATE field indicating when performance of the activity is scheduled to end.

Activity report table 48 includes entries corresponding to particular reports received from users regarding the performance of particular privacy protection activities. As depicted, each entry includes a REPORT_ID field uniquely identifying a electronic report, an ACTIVITY_ID field uniquely identifying a privacy protection activity to which the report pertains, an EVIDENCE_ID field unique identifying evidence associated with the report, a REPORT_DATE field containing the date that the report was prepared, and a REPORT_LIFESPAN field containing an indicator of how long the report is considered to be effective, after which the evidence associated with the report is deemed to be expired. Each entry of activity report table 48 also includes a REPORT_RESPONSE field containing an indicator of whether or not the activity to which the report pertains (as identified by the ACTIVITY_ID field) has been performed.

Activity evidence table 50 includes entries corresponding to a particular piece of evidence received from users for a particular privacy protection activity (e.g., evidencing performance of that activity). As depicted, each entry includes an EVIDENCE_ID field uniquely identifying a piece of evidence, an EVIDENCE_DESCRIPTION field containing a description of the evidence, and an EVIDENCE_LOCATION field identifying a location of the evidence (e.g., by a Uniform Resource Locator address or by physical location).

HTTP server application 34 is a conventional HTTP web server application such as the Apache HTTP Server, nginx, Microsoft IIS, or similar server application. HTTP server application 34 allows server 12 to act as a conventional HTTP server and provides a plurality of web pages of a web site, stored for example as (X)HTML or similar code, for access by interconnected computing devices such as computing devices 14. Web pages may be implemented using traditional web languages such as HTML, XHTML, Java, Javascript, Ruby, Python, Perl, PHP, Flash or the like, and stored in files 38 at server 12.

Reporting/scoring software 36 adapts server 12, in combination with database engine 32, database 40, OS software 30, and HTTP server application 34 to function in manners exemplary of embodiments, as detailed below. Reporting/scoring software 36 may include and/or generate user interfaces written in a language allowing their presentation on a web browser. These user interfaces may be provided in the form of web pages by way of HTTP server application 34 to computing devices 14 over network 10. As will be apparent, users of computing devices 14 may interact with these user interfaces to configure reporting/scoring software 36, to report on the performance of privacy protection activities by an organization and provide evidence thereof, and to receive the organization's performance scores, as calculated by reporting/scoring software 36.

To facilitate reporting and scoring, reporting/scoring software 36 adopts a reporting model including a set of pre-defined privacy protection processes. Such models are used to categorize privacy protection measures implemented by an organization, including polices, practices, procedures, etc., as belonging to one of the pre-defined privacy protection processes. An organization's privacy protection measures may then be assessed according to the extent it has implemented each of the pre-defined privacy protection processes.

In an embodiment, a model used by reporting/scoring software 36 is the Nymity Data Privacy Reporting Model, published by Nymity Inc. (Toronto, Canada). This model includes thirteen pre-defined privacy protection processes. These processes are listed and described in Table I, below.

TABLE I
Example Privacy Protection Processes

| Privacy Protection | | |
|---|---|---|
| Process | | Description |
| 1. | Maintain | Ongoing assurance that there are individuals |
| | Governance | responsible, accountable management, data |
| | Structure | privacy policy and management reporting |
| | | procedures. |
| 2. | Maintain | Maintain an inventory of the location of key |
| | Personal | personal data storage or personal data flows |
| | Data | with defined classes of personal data. |
| | Inventory | |
| 3. | Maintain | Maintain a data privacy policy that meets |
| | Data Privacy | legal requirements and operational risk |
| | Policy | tolerances. |
| 4. | Maintain | Maintain operational policies and procedures |
| | Operational | consistent with data privacy policy, legal |
| | Policies & | requirements and operational risk |
| | Procedures | management. |
| 5. | Ongoing | Ongoing training and awareness to promote |
| | Training & | compliance with data privacy policy and to |
| | Awareness | mitigate operational risks. |
| 6. | Maintain | Maintain an information security program |
| | Security | based on legal requirements and ongoing |
| | Controls | risk assessments. |
| 7. | Maintain | Contracts and agreements with 3rd-parties |
| | Contracts | and affiliates are maintained consistently with |
| | | the data privacy policy, legal requirements |
| | | and operational risk tolerances. |
| 8. | Maintain | Notices to individuals affected are |
| | Notices | maintained consistently with the data privacy |
| | | policy, legal requirements and operational |
| | | risk tolerances. |
| 9. | Manage | Maintain effective procedures and track |
| | Inquiries, | interactions with individuals about their |
| | Complaints & | personal data. |
| | Disputes | |
| 10. | Monitor | Monitor organizational practices to identify |
| | for New | new processes or material changes in |
| | Operational | existing processes and ensure the principle |
| | Practices | of Data Privacy by Design. |
| 11. | Monitor for | |
| | Data Privacy | Maintain an effective breach management |
| | Breaches | program. |
| 12. | Monitor Data | Verify operational practices comply with the |
| | Handling | data privacy policy and operational policies |
| | Practices | and procedures. |
| 13. | Tracking | Track new compliance requirements, |
| | External | expectations and best-practies. |
| | Criteria | |

This model is exemplary only, and other models known to those skilled in the art may also be used. The adopted model may be stored in database 40, e.g., in privacy protection process table 44.

As noted, the above pre-defined privacy protection processes may be used to organize the various privacy protection measures implemented by an organization, including polices, practices, procedures, etc. Each of these measures can be characterized as one or more distinct actions to be performed by the organization or members thereof, hereinafter referred to as “activities”. These activities may, for example, be actions performed to protect personal data or to document steps taken to protect personal data.

As will be appreciated, by characterizing privacy protection measures as distinct actions, implementation of privacy protection measures can be objectively assessed and scored by determining whether or not each of these actions have been performed.

Table II below provides an example set of privacy protection activities defined for the “Maintain Data Privacy Policy” privacy protection process (process 3 in Table I, above).

TABLE II
Example Privacy Protection Activities

| | |
|---|---|
| 1. | Maintain a data privacy policy |
| 2. | Maintain an internal document which has an organization-wide |
| | privacy statement (e.g., statement of principles) |
| 3. | Maintain an employee data privacy policy |
| 4. | Document legal basis for processing personal data |
| 5. | Document guiding principles for consent |
| 6. | Maintain an acceptable use of personal data policy |

Privacy protection activities may vary in importance. In particular, some activities can be categorized as core activities, performance of which can be regarded as mandatory of essential. Other activities can be categorized as elective activities; performance of which can be regarded as optional. Whether or not an activity is a core activity or an elective activity may vary across an organization. For example, the same activity may be a core activity for one organizational unit and an elective activity for another organizational unit, and vice versa. Further, the relative importance of activities may be defined, e.g., by assigning each activity a numerical weight. As detailed below, the importance of privacy protection activities, e.g., whether they are core activities or elective activities, and any assigned numerical weights, may be taken into account when scoring the organization's performance of these activities.

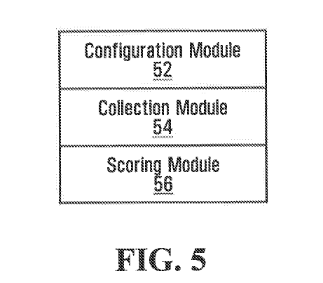

In the embodiment depicted in FIG. 5, reporting/scoring software 36 includes configuration module 52, collection module 54, and scoring module 56. These modules may be written using conventional computing languages such as C, C++, C#, Perl, JavaScript, Java, Visual Basic or the like. These modules may be in the form of executable applications, scripts, or statically or dynamically linkable libraries. The function of each of these modules is detailed below.

Configuration module 52 allows an administrator to configure various parameters of reporting/scoring software 36. To this end, configuration module 52 includes a set of user interfaces taking the form of one or more web pages. Configuration module 52 may receive parameters by way of network 10 from an administrator operating a computing device 14, or from an administrator operating server 12 directly.

Configuration module 52 includes user interfaces configured to allow an administrator to specify an organization's structure. In particular, these user interfaces allow an administrator to specify the organization's structure in terms of its constituent organizational units. As will be apparent, an organization may be organized into organizational units based on one or more of the following criteria: geography, legal jurisdiction, line of business, functional area, business process, management structure, etc. Other ways of organizing an organization into organizational units are possible, as will be apparent to those skilled in the art.

An organization's structure may be specified to have a single structural level (i.e., flat structure), allowing the structure to be specified as a list of organizational units. Alternatively, organizational units may be grouped or subdivided such that the organization's structure corresponds to a tree.

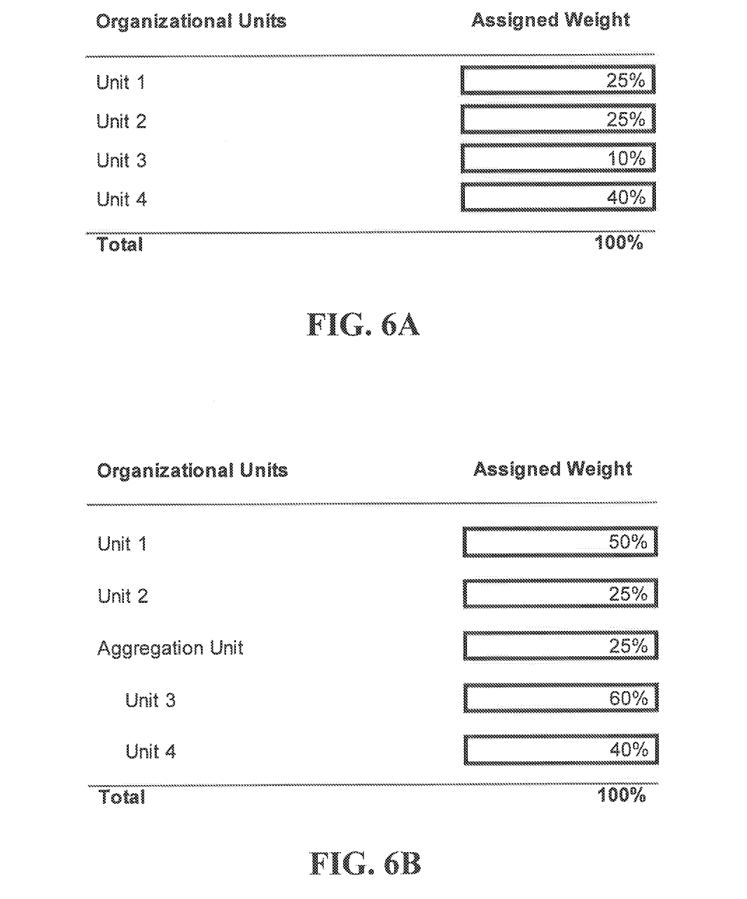

Configuration module 52 also includes user interfaces configured to allow an administrator to define the relative importance of organizational units. The relative importance of organizational units may be specified to reflect their relative size, relative financial importance, relative degree of exposure to personal information, etc. FIGS. 6A and 6B each depict a user interface for specifying the relative importance of organizational units, exemplary of an embodiment.

In particular, FIG. 6A depicts entry of percentage weights reflective of the relative importance of four organizational units of an example organization. The entered weights for the four organizational units sum to 100%. FIG. 6B depicts entry of percentage weights for another example organization, also having four organizational units. Unlike the example organization depicted in FIG. SA, which has a flat structure, the example organization depicted in FIG. SB has a tree structure. As depicted, Organizational Units 3 and 4 are grouped to form an Aggregation Unit. Within this Aggregation Unit, percentage weights of 60% and 40% have been entered for Organizational Units 3 and 4, respectively, which sum to 100%. For the organization as a whole, the percentage weights of Organizational Units 1, 2 and the Aggregation Unit also sum to 100%.

Configuration module 52 may store data relating to the organization's structure, e.g., the organization's constituent organizational units, as well as the relative importance of those organizational units in database 40, e.g., in organizational unit table 42.

In some embodiments, configuration module 52 includes user interfaces configured to allow an administrator to modify the reporting model adopted by the organization. These user interfaces may allow an administrator to modify a pre-existing model such as the Nymity Data Privacy Reporting Model, for example, by adding or removing privacy protection processes. In some embodiments, configuration module 52 includes user interfaces configured to allow an administrator to select from amongst different pre-existing models. In some embodiments, configuration module 52 includes user interfaces configured to allow an administrator to define new models.

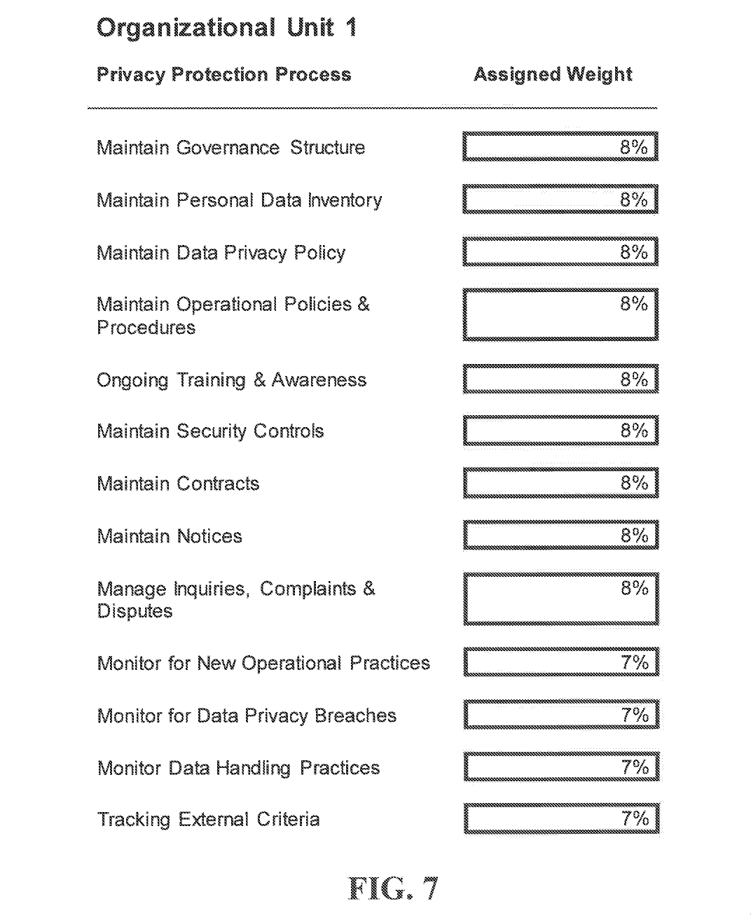

Configuration module 52 also includes user interfaces configured to allow an administrator to specify the relative importance of each pre-defined privacy protection process of the adopted model. The relative importance of each pre-defined privacy protection process may be specified for each organizational unit. FIG. 7 depicts a user interface for specifying the relative importance of each pre-defined privacy protection process for an example organizational unit (Organizational Unit 1), exemplary of an embodiment. As depicted, percentage weights reflective of the relative importance of each of pre-defined privacy processes have been entered. Also as depicted, the pre-defined privacy protection processes are the thirteen processes described above in Table I. As will be appreciated, the percentage weight for a pre-defined privacy protection process may be set to 0%, signifying that the process is not applicable to the organizational unit.

Configuration module 52 may store data relating to the reporting model and the relative importance of privacy protection processes in the reporting model in database 40, e.g., in privacy protection process table 44.

Configuration module 52 includes yet other user interfaces configured to allow an administrator to define a set of privacy protection activities falling within each of the pre-defined privacy protection processes of the adopted model. The privacy protection activities to be performed by an organization may vary throughout the organization, e.g., from organizational unit to organizational unit. Thus, a different set of privacy protection activities may be defined for each privacy protection process implemented by each organizational unit.

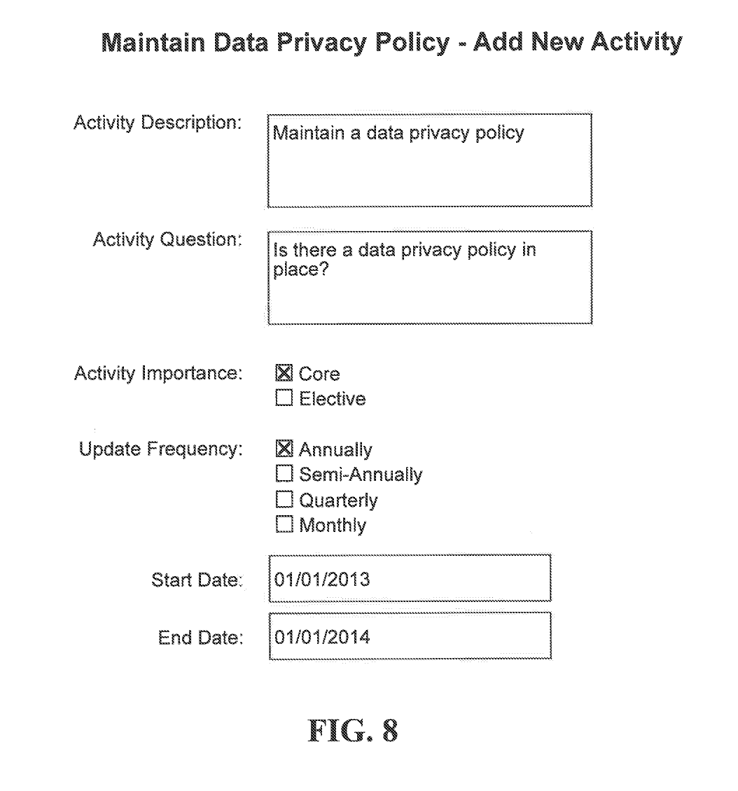

FIG. 8 depicts a user interface for defining a new privacy protection activity, exemplary of an embodiment. As depicted, this interface includes fields allowing an administrator to enter a description for the activity. This interface also includes a field allowing an administrator to enter a question to be posed to users to determine whether or not the activity has been performed. Typically, the question is adapted to elicit a “yes” or “no” response that indicates whether or not the activity has been performed. The interface also includes fields allowing an administrator to specify whether the activity is a core activity (e.g., performance of which is required) or an elective activity (e.g., performance of which is optional). The interface also includes fields allowing an administrator to specify how frequently reports regarding performance of the activity are expected (e.g., annually, semi-annually, quarterly, monthly, etc.) The interface also includes fields allowing an administrator to specify a start date, namely, when performance of the activity is scheduled to commence, and an end date, namely, when performance of the activity is scheduled to end. The end date fields may be left blank for some activities, e.g., if the activity is expected to be performed in perpetuity. Data received by way of this interface are stored by configuration module 52 in database 40, e.g., in privacy protection activity table 46.

In some embodiments, configuration module 52 may allow one or more new activities to be selected from a set of pre-defined activities, stored in, for example, database 40. These pre-defined activities may correspond to commonly used activities, activities pre-defined for particular industries, and/or activities pre-defined to help organizations comply with specific legislation.

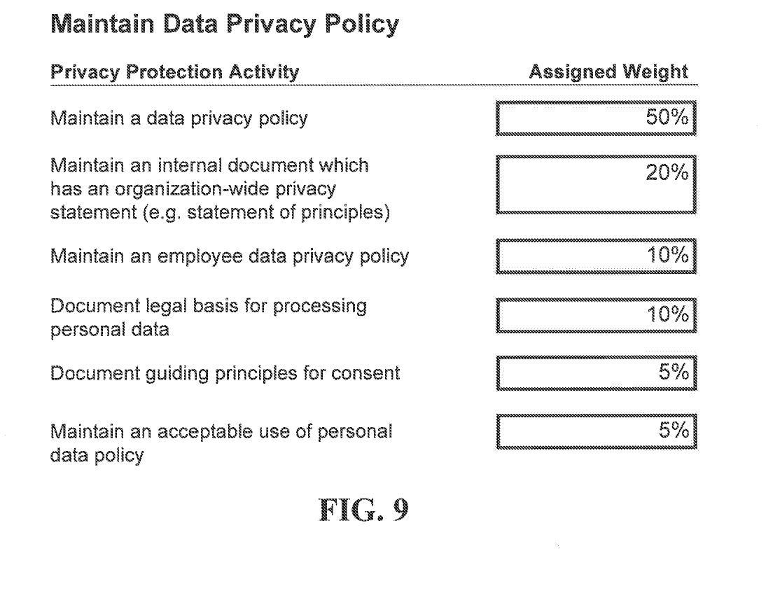

Configuration module 52 also includes user interfaces configured to allow an administrator to specify the relative importance of privacy protection activities in a set defined for a particular privacy protection process and a particular organizational unit. FIG. 9 depicts a user interface for specifying the relative importance of privacy protection activities, exemplary of an embodiment. As depicted, percentage weights reflective of the relative importance of each privacy protection activity in a set of privacy protection activities have been entered for the “Maintain Data Privacy Protection” process (process 3 of the Nymity Data Privacy Repotting Model), for an exemplary organizational unit. These weights may be stored by configuration module 52 in database 40, e.g., in privacy protection activity table 46.

In some embodiments, the relative importance of each privacy protection activity may be automatically determined by configuration module 52, and need not be manually entered. For example, the relative importance of activities may be automatically determined based on historical records reflecting how frequently those activities have been selected in the past by administrators, and/or how frequently reports have been received for those activities from users.

In some embodiments, configuration module 52 periodically searches in database 40 (e.g., in privacy protection activity table 46) to locate and delete entries reflective of activities that are no longer current, i.e., that are no longer to be performed according to its scheduled end date (as stored in the ACTIVITY_END_DATE field). Optionally, entries deleted in this way from database 40 may be archived, e.g., in a separate datastore.

Collection module 54 allows users, e.g., users operating computer devices 14, to submit electronic reports, from time to time, reporting whether or not an organizational unit has performed the privacy protection activities defined for that organizational unit. Collection module 54 may receive reports from a user situated centrally in the organization, e.g., in the organization's privacy office. Alternatively, collection module 54 may receive reports from users situated throughout the organization. In this way, collection module 54 facilitates collaborative reporting of data relating to the organization's performance of the privacy protection activities.

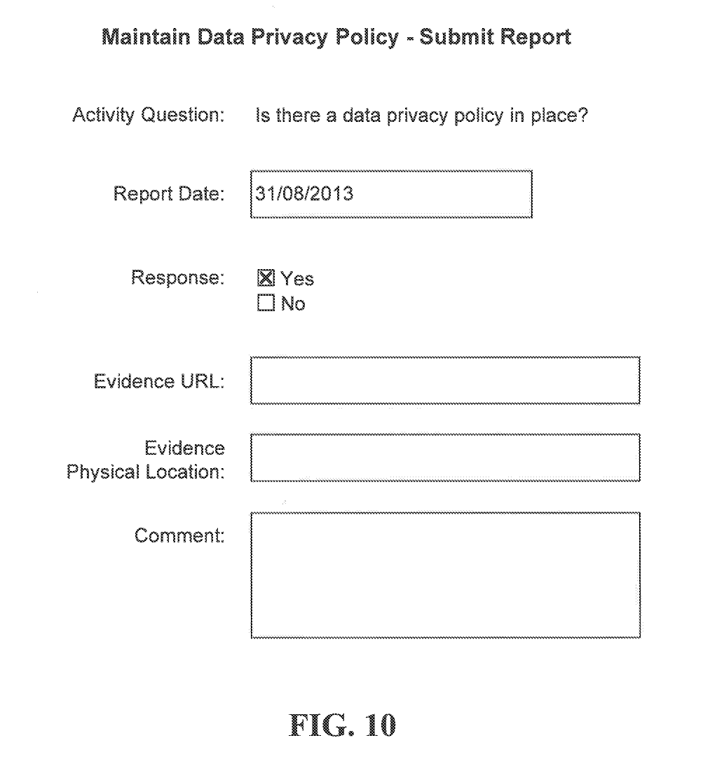

To facilitate submission of electronic reports by users, collection module 54 presents one or more user interfaces to users prompting them to report whether or not an organizational unit has performed particular privacy protection activities. Such user interfaces are generated by collection module 54 to prompt users to report on the privacy protection activities defined for particular privacy protection processes and particular organizational units. To this end, collection module 54 may retrieve data regarding defined privacy protection activities database 40, e.g., in privacy protection activity table 46. An example user interface generated by collection module 54 is depicted in FIG. 10, exemplary of an embodiment.

This user interface is presented to a user to prompt the user to report whether or not a particular activity (namely, “Maintain data privacy policy”), has been performed by a particular organizational unit. As depicted in FIG. 10, the user interface is configured to present a question (namely, “Is there a data privacy policy in place?”), prompting a user to consider whether or not the particular privacy protection activity has been performed.

As depicted, this user interface includes a field allowing a user to respond “yes” or “no” to the question posed, where a response of “yes” indicates that the organizational unit has performed the particular privacy protection activity subject of the report, and a response of “no” indicates that the organizational unit has not performed that activity. In some embodiments, if a user provides a “no” response, additional fields may be presented to the user to enter a future date when performance is planned to begin.

This user interface also includes fields allowing a user to provide evidence that the organizational unit has performed the particular privacy protection activity, as reported. As depicted, the user interface includes a field allowing a user to provide evidence by identifying a Uniform Resource Locator for that evidence, which may be used, for example, when the evidence is in the form of an electronic document. The user interface also includes a field allowing a user to provide evidence by identifying a physical location of the evidence, which may be used, for example, when the evidence is a physical document. In other embodiments, the user interface may be configured to allow a user to provide evidence by submitting an electronic document to collection module 54 (e.g., by way of an HTTP transfer or an e-mail attachment).

Collection module 54 requires a user to provide evidence in every report that indicates that the organization has performed the particular privacy protection activity subject of the report (e.g., whenever a response of “yes” is provided in the report). In some embodiments, the user interface depicted in FIG. 10 may be configured to prevent a user from submitting a report with a “yes” response if the evidence fields are left blank. Conveniently, this ensures that all reports indicating a privacy protection activity has been performed is supported by evidence.

Each report has a lifespan, after which any evidence provided in the report is deemed to have expired. The lifespan for a report corresponds to the expected reporting frequency set for a particular privacy protection activity. For example, if the expected reporting frequency for a particular privacy protection activity is set to monthly (e.g., in the ACTIVITY_UPDATE_FREQUENCY field of privacy protection activity table 46), then the lifespan of any report regarding performance of this activity will be one month. Similarly, if the expected reporting frequency for a particular privacy protection activity is set to annually, then the lifespan of any report will be one year. The lifespan of a report is measured from a report date. To this end, the user interface depicted in FIG. 10 also includes a field allowing a user to enter a report date.

Report data and evidence data received by configuration module 52 are stored in database 40, e.g., in activity report table 46 and activity evidence table 50, respectively.

Collection module 54 periodically searches database 40 (e.g., in ACTIVITY_REPORT table 48) to locate entries reflective of reports containing evidence deemed to have expired. In some embodiments, collection module 54 then updates such entries to change the REPORT_RESPONSE field from “yes” to “expired”. This indicates that the evidence in the report has expired. If there are no reports for a particular privacy protection activity that contain unexpired evidence, then that activity is considered to have not been performed due to lack of current evidence. In other embodiments, entries reflective of reports containing evidence deemed to have expired are deleted. Optionally, entries deleted from database 40 may be archived, e.g., in a separate datastore.

In the depicted embodiment, each report contains data relating to performance of one privacy protection activity by one organizational unit. In other embodiments, each report may contain data relating to performance of multiple activities, such as, for example, all of the activities defined for a particular organizational unit, or all of the activities defined for the organization.

Collection module 54 may receive electronic reports in the form of HTTP messages by way of HTTP server 34. In alternate embodiments, collection module 54 may receive electronic reports in other suitable forms such as, for example, e-mail messages. Yet other suitable forms will also be readily apparently to those of ordinary skill in the art.

Scoring module 56 scores the organization's performance of privacy protection activities, taking into account the reports received by collection module 54. In this way, scoring is performed automatically. Further, as will become apparent, scoring takes into account reports providing current evidence of the organization's performance of privacy protection activities, while disregarding any reports providing expired evidence.

In the depicted embodiment, scoring module 56 calculates a plurality of scores, each score reflective of the extent of performance of a set of privacy protection activities defined for a particular organizational unit and a particular privacy protection process. Further, separate scores are calculated for performance of core activities and performance of elective activities.

For each set of privacy protection activities, scoring module 56 counts the number of current activities, namely, those activities scheduled to be performed in the current time period (e.g., as determined from the ACTIVITY_START_DATE and ACTIVITY_END_DATE fields in privacy protection activity table 46). Of these current activities, scoring module 56 counts the number of activities for which performance has been reported and evidence of that performance has not expired. The score is then calculated as the percentage of current activities that have been performed, taking into account only those reports providing unexpired evidence. For example, if unexpired evidence indicates that 5 out of 10 current activities are being performed, then the score is calculated to be 50%.

In some embodiments, the score may be labeled according to whether it is calculated for a set of core activities or a set of elective activities. In particular, a score calculated for a set of core activities may be labeled as a “managed” score, while a score calculated for a set of elective activities may be labeled as an “advanced” score. For example, if the evidence indicates that 7 out of 10 core activities are being performed, then the score is 70% “managed”. If the evidence indicates that 2 out of 10 elective activities are being performed, then the score is 20% “advanced”. Further, in some of these embodiments, the score calculated for a set of elective activities for a particular privacy protection process and a particular organizational unit is considered merely a potential score, unless the score calculated for a set of core activities for the same privacy protection process and the same organizational unit is 100%. In other words, the score for elective activities is considered a potential score unless all related core activities have been performed.

In some embodiments, calculating the score for a set of privacy protection activities may take into account the relative importance of those activities, for example, as represented by the numerical weights stored in the ACTIVITY_WEIGHT field of privacy protection activity table 46. For example, the score could be calculated as a weighted sum of activities for which performance has been reported, divided by a weight sum of all activities.

Further, an aggregate score for an organizational unit can be calculated. In some embodiments, this aggregate score can be calculated as the weighted sum of the individual scores calculated for that organizational unit for each of the pre-defined privacy protection processes, where the weights are stored for each of the processes, for example, in the PROCESS_WEIGHT field of privacy protection process table 44. A yet further aggregate score for the entire organization can be calculated as well. In some embodiments, this aggregate score for the organization can be calculated as the weighted sum of the scores calculated for each of the organization's constituent organizational units, where the weights are stored for each of the organizational units, for example, in the UNIT_WEIGHT field of organization unit 42.

Other ways of calculating scores reflective of the extent of an organization's performance of privacy protection activities will also be apparent to those of ordinary skill in the art. Scores calculated in these other ways may be used in addition to or instead of the scores calculated in the manners described above.

Scoring module 56 may calculate scores in the manners described above automatically upon receipt of a new report, or when evidence in a received report is deemed to have expired. Scoring module 56 may calculate scores upon user request. Scoring module 56 may also calculate scores periodically according to a pre-defined schedule (e.g., monthly, quarterly, semi-annually, or annually). Calculated scores may be stored, for example, in database 40. This allows scoring of an organization's performance of privacy protection activities to be tracked over time.

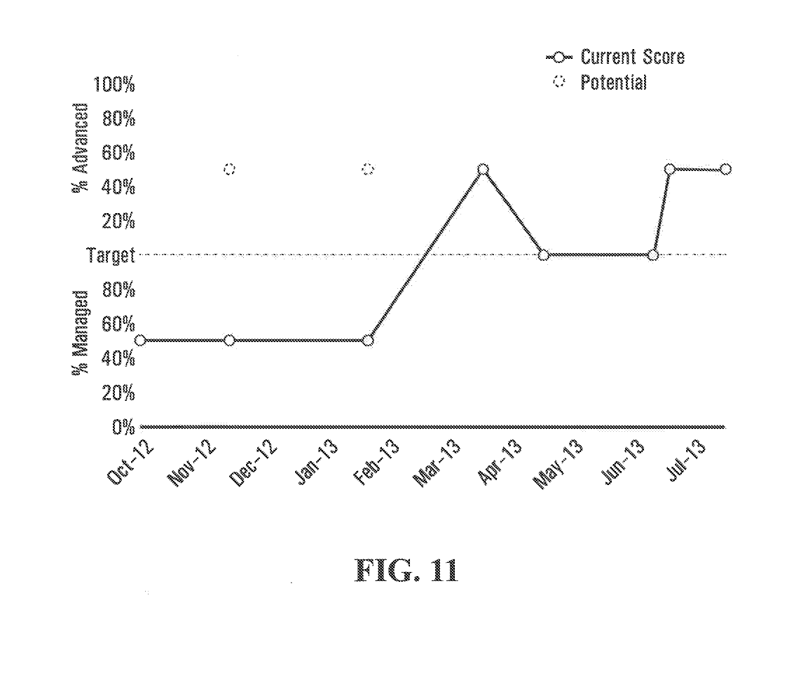

Scoring module 56 generates reports summarizing scoring results to users. Reports are then presented to users, e.g., in the form of web pages provided by HTTP server 34. Reports may show scoring results in the form of one or more tables, charts, or graphs. FIG. 11 shows a portion of such a report, exemplary of an embodiment. As depicted, this report includes a graph showing scores calculated for performance of privacy protection activities in a particular privacy protection process by a particular organizational unit. Conveniently, scores for both core activities and elective activities are shown in a single graph. As discussed above, scores for elective activities are shown as “potential” scores when the score for core activities is not 100%, i.e., when not all core activities have been performed. In particular, in this graph, the score shown is the “managed score” when the “advanced” score is merely a potential score (not all core activities have been performed), e.g., in November 2012 and December 2012. However, when all core activities have been performed, the score shown is the “advanced” score, e.g., in March 2013.

Reports generated by scoring module 56 may be used by an organization to assess compliance with privacy legislation. Assessment of compliance may be conducted, for example, using the methods, devices, and software described in U.S. application Ser. No. 13/715,958, the contents of which are hereby incorporated by reference.

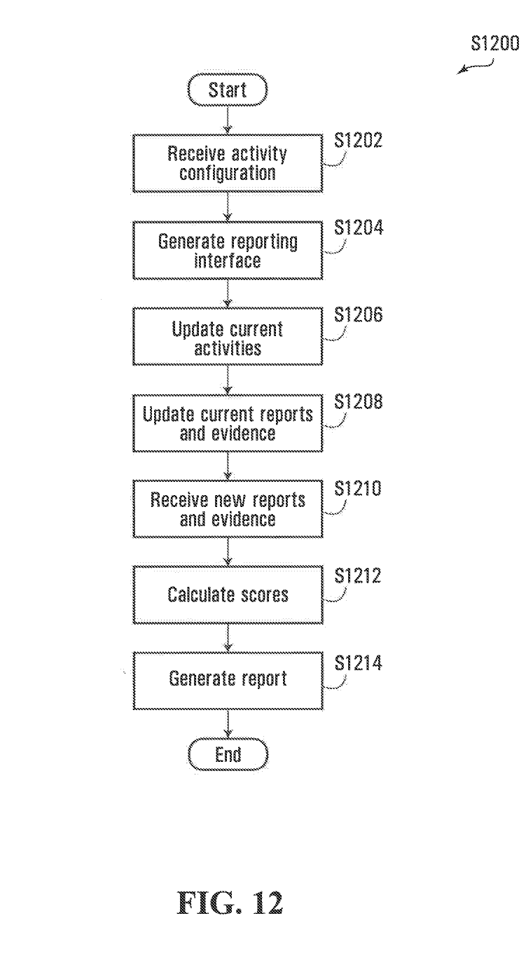

The operation of reporting/scoring software 36 is further described with reference to the flowchart illustrated in FIG. 12.

Reporting/scoring software 36 performs blocks S1200 and onward at server 12. At block S1202, configuration module 52 receives configuration parameters from an administrator. These configuration parameters include parameters describing organizational structure, e.g., the organization's constituent organizational units, as well as characteristics of the organization and its organizational units. These configuration parameters also include weights reflective of the relative importance of each organizational unit, which may be received by configuration module 52 by way of the user interface depicted in FIG. 6A (or FIG. 6B). These configuration parameters also include weights reflective of the relative importance of each pre-defined privacy protection process of the adopted reporting model for each organizational unit, which may be received by configuration module 42 by way of the user interface depicted in FIG. 7.

At block S1202, configuration module 52 also receives configuration parameters describing the various privacy protection activities to be performed by the organization. These configuration parameters may be received by configuration module 52 by way of the user interface depicted in FIG. 8. These configuration parameters include a description of each activity, a question associated with each activity, indicators of whether each activity is a core activity or an elective activity, how frequently reports are expected for that activity, and start/end dates for that activity. These configuration parameters also include weights reflective of the relative importance of each privacy protection activity, which may be received by configuration module 52 by way of the user interface depicted in FIG. 9.

In this way, configuration module 52 receives parameters for a set of privacy protection activities for each of the pre-defined privacy protection processes implemented by each of the organization's organizational units. As noted, configuration module 52 stores received configuration parameters in database 40, e.g., in the tables shown in FIG. 4.

At block S1204, collection module 54 generates user interfaces configured to prompt users to report on the organization's performance of privacy protection activities. Collection module 52 generates these user interfaces based on the parameters received in block S1202 for particular privacy protection activities. The user interfaces include forms that may be filled by users to report on the performance of a particular privacy protection activity, as depicted, for example in FIG. 8.

Collection module 54 then receives electronic reports from users by way of these user interfaces. Each report includes an indicator of whether or not a particular organizational unit has performed a particular privacy protection activity. Further, each report provides evidence that the organizational unit has performed the particular privacy protection activity, as reported. The reported data are stored by collection module 54 in database 40.

Optionally, at block S1206, configuration module 52 may search in database 40 to locate and delete entries reflective of activities that are no longer current, i.e., the scheduled end date has passed.

Optionally, at block S1208, collection module 54 may search in database 40 to locate entries reflective of reports containing evidence deemed to have expired. Collection module 54 may update such entries to indicate that the activity has not been performed, or simply delete such entries.

At block S1210, collection module 54 may receive further reports from users. In some cases, a new report may be received for privacy protection activities previously reported to have been performed. Such reports may provide new evidence that the activity has been performed, or indicate that previously-submitted evidence is still current. In this way, evidence may be refreshed.

At block S1202, scoring module S1212 scores the organization's performance of privacy protection activities, taking into account the reports received by collection module 54. As noted, scoring takes into account only those reports providing current evidence of the organization's performance of privacy protection activities, while disregarding any reports providing expired evidence. Scores may be calculated for each set of privacy protection activities, i.e., for each privacy protection process implemented by each organizational unit. Aggregate scores may be calculated for an organizational unit, reflective of extent of performance of privacy protection activities for all processes implemented by that organizational unit. Further, aggregate scores may be calculated for the entire organization, reflective of extent of performance of all privacy protection activities.

Reports summarizing the scoring results are then generated and presented to users at block S1204.

Of course, the above described embodiments are intended to be illustrative only and in no way limiting. The described embodiments are susceptible to many modifications of form, arrangement of parts, details and order of operation. For example, software (or components thereof) described at computing device 12 may be hosted at several devices. Software implemented in the modules described above could be implemented using more or fewer modules. The invention is intended to encompass all such modification within its scope, as defined by the claims.

What is claimed is:

1. A computer-implemented method of scoring performance of a plurality of privacy protection activities by an organization, said method comprising:
receiving a plurality of electronic reports, each of said electronic reports indicating that said organization performs one of said plurality of privacy protection activities and providing evidence that said organization has performed said privacy protection activity;
maintaining a plurality of lifespan metrics, each measuring a lifespan for an associated one of said electronic reports, after which said evidence provided in that electronic report is deemed to have expired; and
calculating a score reflective of extent of performance of said plurality of privacy protection activities by said organization, taking into account those of said plurality of electronic reports providing evidence that has not expired.

2. The method of claim 1, wherein said calculating takes into account importance of each of said plurality of privacy protection activities relative to others of said plurality of privacy protection activities.

3. The method of claim 1, wherein each of said plurality of privacy protection activities is classified as a mandatory activity or an optional activity.

4. The method of claim 3, wherein said calculating takes into account whether each of said plurality of privacy protection activities is a mandatory activity or an optional activity.

5. The method of claim 1, wherein said organization is organized as a plurality of organizational units, and each of said electronic reports indicates that a particular one of said plurality organizational units performed a particular one of said plurality of privacy protection activities.

6. The method of claim 5, wherein said calculating takes into account Importance of each of said plurality of organizational units relative to others of said plurality of organizational units.

7. The method of claim 1, wherein said plurality of privacy protection activities are organized into groups, each group corresponding to one of a plurality of pre-defined privacy protection processes.

8. The method of claim 8, wherein said calculating takes into account importance of each of said plurality of pre-defined privacy protection processes relative to others of said plurality of pre-defined privacy protection processes.

9. The method of claim 1, wherein said calculating comprises determining a percentage of said plurality privacy protection activities for which electronic reports have been received.

10. The method of claim 1, further comprising generating an electronic report containing said calculated score and presenting said electronic report to a user.

11. The method of claim 10, wherein said electronic report comprises a graph showing calculated scores plotted against time.

12. The method of claim 1, further comprising storing said plurality of electronic reports in a datastore.

13. The method of claim 12, further comprising automatically deleting those of said plurality of electronic reports providing evidence that has expired from said datastore.

14. The method of claim 1, further comprising generating a user interface for receiving a electronic report for a particular one of said plurality of privacy protection activities.

15. The method of claim 14, wherein said user interface is presented to a user by way of a web browser.

16. The method of claim 1, wherein said evidence comprises an electronic document or an identifier thereof.

17. The method of claim 16, wherein said identifier is a Universal Resource Locator.

18. The method of claim 1, wherein at least one of said plurality of electronic reports is received by way of a computer network.

19. A computing device for scoring performance of a plurality of privacy protection activities by an organization, said device comprising:
at least one processor;
memory in communication with said at least one processor; and
software code stored in said memory, which when executed by said at least one processor causes said computing device to:
receive a plurality of electronic reports, each of said electronic reports indicating that said organization performs one of said plurality of privacy protection activities and providing evidence that said organization has performed said privacy protection activity;
maintain a plurality of lifespan metrics, each measuring a lifespan for an associated one of said electronic reports, after which said evidence provided in that electronic report is deemed to have expired; and
calculate a score reflective of extent of performance of said plurality of privacy protection activities by said organization, taking into account those of said plurality of electronic reports providing evidence that has not expired.

20. A computer-readable medium storing instructions which when executed adapt a computing device to:
receive a plurality of electronic reports, each of said electronic reports indicating that a organization performs a particular privacy protection activity of a plurality of privacy protection activities, and providing evidence that said organization has performed said particular privacy protection activity;
maintain a plurality of lifespan metrics, each measuring a lifespan for an associated one of said electronic reports, after which said evidence provided in that electronic report is deemed to have expired; and
calculate a score reflective of extent of performance of said plurality of privacy protection activities by said organization, taking into account those of said plurality of electronic reports providing evidence that has not expired.

21. A computer-implemented method of scoring performance of a plurality of privacy protection activities by an organization, said method comprising:
receiving a plurality of electronic reports, each of said electronic reports indicating that said organization performs one of said plurality of privacy protection activities and providing evidence that said organization has performed said privacy protection activity; and
calculating a score reflective of extent of performance of said plurality of privacy protection activities by said organization, taking into account said plurality of electronic reports.
